(19) United States
(12) Patent Application Publication
(10) Pub. No.: US 2004/0206865 A1
(43) Pub. Date: Oct. 21, 2004

(54) Position confining device of a dovetail machine

(76) Inventor: Chi-Lo Chang, Taichung Hsien (TW)

Correspondence Address: CHARLES E. BAXLEY, ESQ., 90 JOHN STREET, THIRD FLOOR, NEW YORK, NY, 10038, US

(21) Appl. No.: 10/641,923

(22) Filed: Aug. 12, 2003

(30) Foreign Application Priority Data
Apr. 16, 2003 (TW) 092205988

(51) Int. Cl. F16M 11/00

(52) U.S. Cl. 248/200

(57) ABSTRACT

A position confining device of a dovetail machin has a panel, a pair of locking blocks, and a plurality of fastening bolts. The panel has at least two through holes. Each locking block has a locking plate, a protruded ring disposed on the locking plate, an inner post disposed on the locking plate and surrounded by the protruded ring, and a groove defined by the inner post and the protruded ring. Each protruded ring is inserted in the corresponding through hole of the panel. Each fastening bolt fastens the corresponding locking plate and the panel.

### BACKGROUND OF THE INVENTION

The pr sent invention relates to a position confining device of a dovetail machine. More particularly, the present invention relates to a position confining device which has a pair of locking blocks.

Referring to FIGS. 1 to 3, a dovetail machine has a platform 11, a drive device 12 disposed in the platform 11, a first T-shaped frame 13 disposed on the platform 11 along a Z axis, a base plate 14 disposed on the first T-shaped frame 13 along the Z axis, a second T-shaped frame 15 disposed on the base plate 14 along the Z axis, a cross-shaped frame 16 disposed on the second T-shaped frame 15 along the Z axis, a position confining panel 17 disposed on the cross-shaped frame 16 along the Z axis, and a pair of pins 18. The drive device 12 has a motor 121, a worm 122, a pair of driven shafts 123 disposed on two ends of the worm 122, and a belt 124 connected to the motor 121 and the worm 122. The worm 122 and the driven shafts 123 are arranged along a Y axis. A portion of each driven shaft 123 will be inserted through the platform 11. The cross-shaped frame 16 has a main bar 161 covering the second T-shaped frame 15, and a pair of wing bars 162 extending from the main bar 161 along the Y axis. The wing bars 162 cover the driven shafts 123. The position confining panel 17 cov rs a portion of the platform 11. The position confining panel 17 has a pair of oblong recesses 172 formed on a bottom 171 of the position confining panel 17. Each of the pins 18 is inserted in the corresponding oblong recess 172 of the position confining panel 17 and inserted through the corresponding wing bar 162. When the motor 121 drives the belt 124 to rotate, the belt 124 will drive the worm 122 to rotate. Since the driven shafts 123 are disposed on two ends of the worm 122, the driven shafts 123 will drive the cross-shaped frame 16 to perform a motion along an elliptical locus. The pins 18 and the oblong recesses 172 of the position confining panel 17 will confine the motion of the cross-shaped frame 16. The cross-shaped frame 16 will drive the second T-shaped frame 15 to perform a linear displacement along an X axis (as shown in FIGS. 2 and 3). Since the oblong recesses 172 are formed on the bottom 171 of the position confining panel 17, the size of each oblong recess 172 cannot be varied in order to change the elliptical locus of the motion of the cross-shaped frame 16. If the distance of the linear displacement of the second T-shaped frame 15 is varied, the size of each oblong recess 172 should be varied also. Therefore, many position confining panels 17 should b pr par d. Furthermore, th oblong recesses 172 of the position confining panel 17 will be enlarged after a long period of usage. Then a pr cision of the linear displacement of the second T-shaped frame 15 will be decreased, so the position confining panel 17 should be replaced. It is difficult to detach the position confining panel 17 because the position confining panel 17 has a large size. It is expensive to replace the position confining panel 17 very often whenever the oblong recesses 172 of the position confining panel 17 are enlarged.

### SUMMARY OF THE INVENTION

An object of the present invention is to provide a position confining device of a dovetail machine which has a pair of locking blocks to be replaced easily.

Another object of the present invention is to provide a panel having a pair of through holes to engage with a pair of locking blocks stably. Whenever the locking blocks are replaced, it is not necessary to replace the panel.

Accordingly, a position confining device of a dovetail machine comprises a panel, a pair of locking blocks, and a plurality of fastening bolts. The panel has at least two through holes. Each locking block has a locking plate, a protruded ring disposed on the locking plate, and an inner post disposed on the locking plate and surrounded by the protrud d ring. Each protruded ring is inserted in the corr sponding through hol of the panel. Each fastening bolt fastens the corresponding locking plate and the panel.

### BRIEF DESCRIPTION OF THE DRAWINGS

FIG. 1 is a perspective exploded view of a dovetail machine of the prior art;

FIG. 2 is a schematic view illustrating a first operation of a dovetail machine of the prior art;

FIG. 3 is a schematic view illustrating a second operation of a dovetail machine of the prior art;

FIG. 4 is a perspective exploded view of a position confining device of a dovetail machine of a preferred embodiment in accordance with the present invention;

FIG. 5 is a perspective assembly view of a position confining device of a dovetail machine of a preferred embodiment in accordance with the present invention; and

FIG. 6 is a sectional view taken along line 6-6 in FIG. 5.

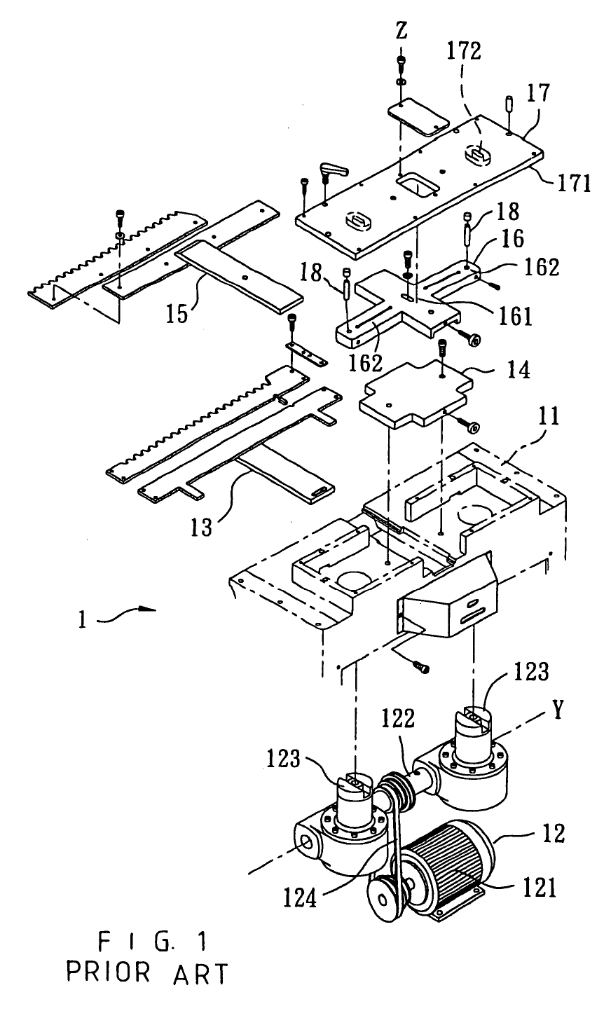

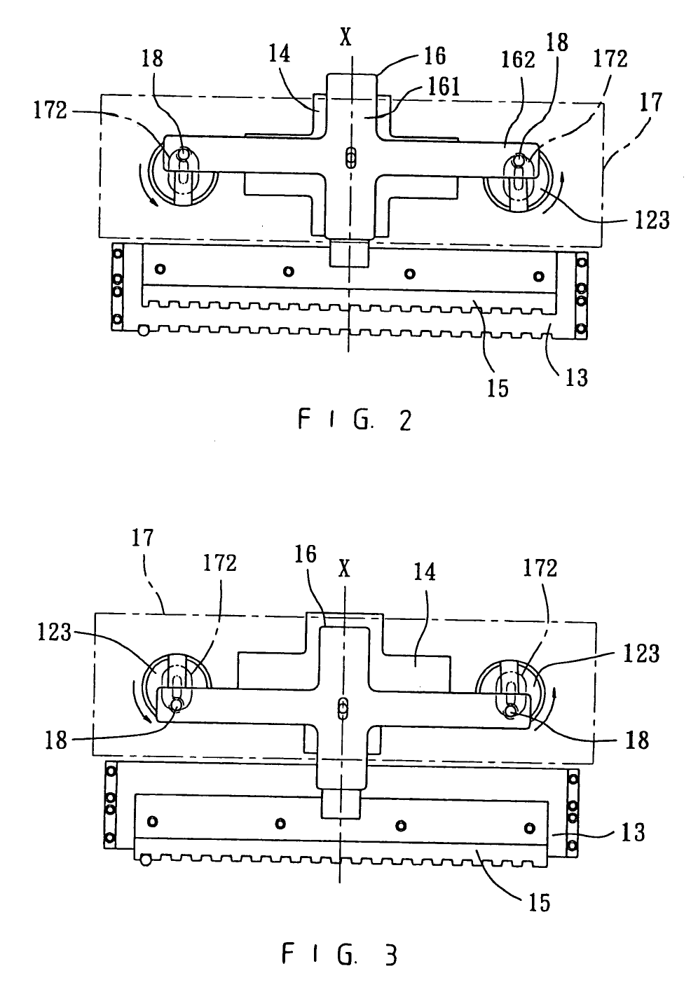

### DETAILED DESCRIPTION OF THE INVENTION

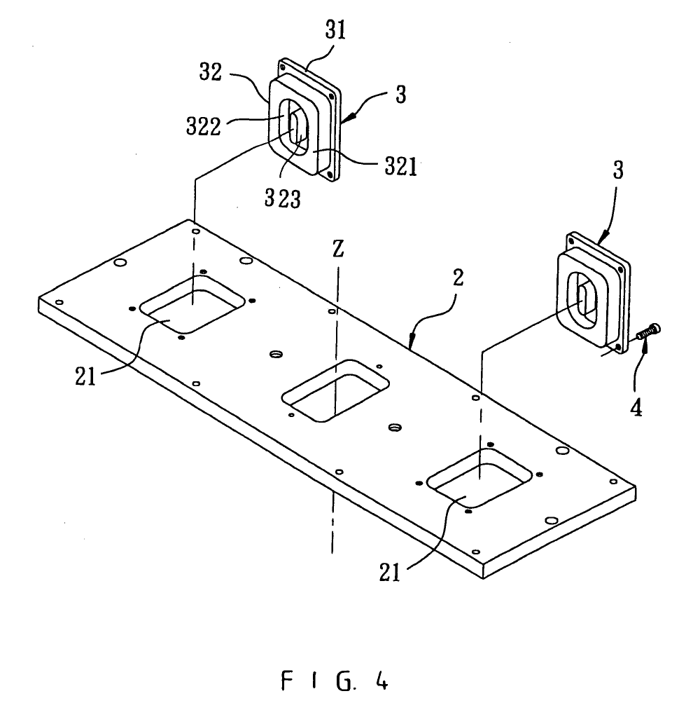

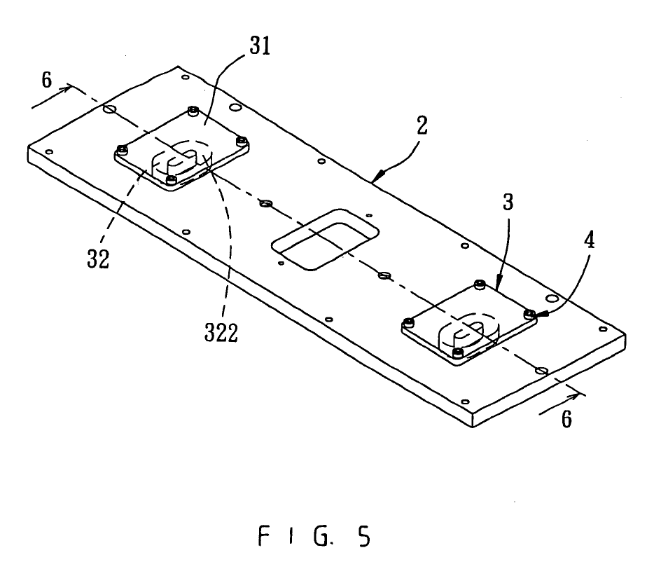

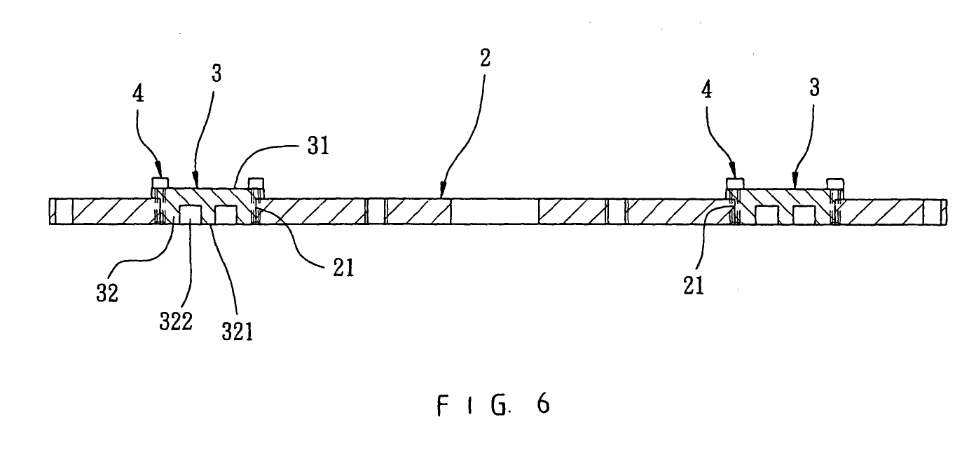

Referring to FIGS. 4 to 6, a position confining device of a dovetail machine comprises a panel 2, a pair of locking blocks 3, and a plurality of fastening bolts 4.

The panel 2 has at l ast two through holes 21.

Each locking block 3 has a locking plat 31, a protruded ring 32 disposed on th locking plate 31, an inner post 323 disposed on the locking plate 31 and surrounded by the protruded ring 32, and a groove 322 defined by the inner post 323 and the protruded ring 32.

Each protruded ring 32 is inserted in the corresponding through hole 21 of the panel 2 along a Z axis.

Each fastening bolt 4 fastens the corresponding locking plate 31 and the panel 2.

Each through hole 21 of the panel 2 has an oblong shape.

Each protruded ring 32 has a bottom face 321 facing a bottom of the panel 2.

Each inner post 323 has an elliptical shape.

Each locking plate 31 has an oblong shape.

Each protruded ring 32 has an oblong shape to match the corresponding through hole 21 of the panel 2.

The present invention provides the position confining device to replace a conventional position confining panel.

A pin (not shown in the figures) is inserted in the corresponding groove 322 of the locking block 3.

When the groove 322 of the locking block 3 is enlarged, the locking block 3 will be replaced. Therefore, it is not necessary to detach the panel 2 and to replace the panel 2.

When the fastening bolts 4 are removed, the locking blocks 3 are detached from the panel 2.

The present invention has the following advantages.

A size of the locking block is smaller than a size of the panel. It is easier to replace the locking block than to replace the panel.

It is expensive to replace the panel very often, but it is not expensive to replace the locking block very often.

Since the size of the locking block is small, it is not expensive to make the locking block with a wear resisting material.

The present invention is not limited to the above embodiment but various modification thereof may be made. Furthermore, various changes in form and detail may be made without departing from the scope of the present invention.

I claim:

1. A position confining device of a dov tail machine comprises:
a panel, a pair of locking blocks, and a plurality of fastening bolts,
the panel having at least two through holes,
each said locking block having a locking plate, a protruded ring disposed on the locking plate, and an inner post disposed on the locking plate and surrounded by the protruded ring,
each said protruded ring inserted in the corresponding through hole of the panel, and
each said fastening bolt fastening the corresponding locking plate and the panel.

2. The position confining device of a dovetail machine as claimed in claim 1, wherein each said through hole of the panel has an oblong shape.

3. The position confining device of a dovetail machine as claimed in claim 1, wherein a groove is defined by the inner post and the protruded ring.

4. The position confining device of a dovetail machine as claimed in claim 1, wherein each said inner post has an elliptical shape.

5. The position confining device of a dovetail machine as claimed in claim 1, wherein each said locking plate has an oblong shape.

6. The position confining device of a dovetail machine as claimed in claim 2, wh rein each said protruded ring has an oblong shape to match the corr sponding through hole of the panel.
